(19) United States
(12) Patent Application Publication
(10) Pub. No.: US 2020/0335973 A1
(43) Pub. Date: Oct. 22, 2020

(54) ENERGY TRANSFER THROUGH FLUID FLOWS

(71) Applicant: Energy Harbors Corporation, Inc., Saratoga, CA (US)

(72) Inventors: Shankar Ramamurthy, Saratoga, CA (US); Robert A. Gingell, Sunnyvale, CA (US)

(21) Appl. No.: 16/857,854

(22) Filed: Apr. 24, 2020

Related U.S. Application Data
(63) Continuation-in-part of application No. 16/747,843, filed on Jan. 21, 2020.
Application No. 16/747,843 is a continuation-in-part of application No. 16/378,243, filed on Apr. 8, 2019.
Application No. 16/378,243 is a continuation-in-part of application No. 16/118,886, filed on Aug. 31, 2018, now Pat. No. 10,725,441.
(60) Provisional application No. 62/981,629, filed on Feb. 26, 2020.
(60) Provisional application No. 62/916,449, filed on Oct. 17, 2019.
(60) Provisional application No. 62/838,992, filed on Apr. 26, 2019.
(60) Provisional application No. 62/795,133, filed on Jan. 22, 2019.
(60) Provisional application No. 62/795,140, filed on Jan. 22, 2019.
(60) Provisional application No. 62/784,582, filed on Dec. 24, 2018.
(60) Provisional application No. 62/679,051, filed on Jun. 1, 2018.
(60) Provisional application No. 62/654,718, filed on Apr. 9, 2018.
(60) Provisional application No. 62/654,859, filed on Apr. 9, 2018.
(60) Provisional application No. 62/552,747, filed on Aug. 31, 2017.
(60) Provisional application No. 62/645,859, filed on Mar. 21, 2018.

(51) Int. Cl. H02J 3/28; G06Q 50/06

(52) U.S. Cl. CPC H02J 3/28; H02J 15/003; G06Q 50/06

(57) ABSTRACT

Disclosed techniques include energy management transfer through fluid flows. Access to a fluid-based local energy transfer distribution network is obtained. The fluid-based local energy transfer distribution network can include a homogeneous fluid in liquid and gaseous phases. One or more fluid-based energy storage and generation assemblies are connected to the fluid-based local energy transfer distribution network. Energy is provided to the one or more fluid-based energy storage and generation assemblies. Fluid-based energy is delivered to the fluid-based local energy transfer distribution network, where the delivering is based on an energy control management system executing on one or more processors. The delivering includes providing local fluid-based services, where the local fluid-based services supply local consumer applications. The local applications can include a water nozzle, an air nozzle, a water Venturi function, an air Venturi function, a vacuum supply, space heating, a fluid-based rotation, space cooling, hot water, or cold water.

### RELATED APPLICATIONS

This application claims the benefit of U.S. provisional patent applications “Energy Transfer Through Fluid Flows” Ser. No. 62/838,992, filed Apr. 26, 2019, “Desalination Using Pressure Vessels” Ser. No. 62/916,449, filed Oct. 17, 2019, and “Controlled Liquefaction and Energy Management” Ser. No. 62/981,629, filed Feb. 26, 2020.

This application is also a continuation-in-part of U.S. patent application “Energy Management Using a Converged Infrastructure” Ser. No. 16/747,843, filed Jan. 21, 2020, which claims the benefit of U.S. provisional patent applications “Energy Management Using a Converged Infrastructure” Ser. No. 62/795,140, filed Jan. 22, 2019, “Energy Management Using Electronic Flywheel” Ser. No. 62/795,133, filed Jan. 22, 2019, “Energy Transfer Through Fluid Flows” Ser. No. 62/838,992, filed Apr. 26, 2019, and “Desalination Using Pressure Vessels” Ser. No. 62/916,449, filed Oct. 17, 2019.

The U.S. patent application “Energy Management Using a Converged Infrastructure” Ser. No. 16/747,843, filed Jan. 21, 2020 is also a continuation-in-part of U.S. patent application “Energy Storage and Management Using Pumping” Ser. No. 16/378,243, filed Apr. 8, 2019, which claims the benefit of U.S. provisional patent applications “Modularized Energy Management Using Pooling” Ser. No. 62/654,718, filed Apr. 9, 2018, “Energy Storage and Management Using Pumping” Ser. No. 62/654,859, filed Apr. 9, 2018, “Power Management Across Point of Source to Point of Load” Ser. No. 62/679,051, filed Jun. 1, 2018, “Energy Management Using Pressure Amplification” Ser. No. 62/784,582, filed Dec. 24, 2018, “Energy Management Using a Converged Infrastructure” Ser. No. 62/795,140, filed Jan. 22, 2019, and “Energy Management Using Electronic Flywheel” Ser. No. 62/795,133, filed Jan. 22, 2019.

The U.S. patent application “Energy Storage and Management Using Pumping” Ser. No. 16/378,243, filed Apr. 8, 2019, is also a continuation-in-part of U.S. patent application “Energy Management with Multiple Pressurized Storage Elements” Ser. No. 16/118,886, filed Aug. 31, 2018, which claims the benefit of U.S. provisional patent applications “Energy Management with Multiple Pressurized Storage Elements” Ser. No. 62/552,747, filed Aug. 31, 2017, “Modularized Energy Management Using Pooling” Ser. No. 62/654,718, filed Apr. 9, 2018, “Energy Storage and Management Using Pumping” Ser. No. 62/654,859, filed Apr. 9, 2018, and “Power Management Across Point of Source to Point of Load” Ser. No. 62/679,051, filed Jun. 1, 2018.

Each of the foregoing applications is hereby incorporated by reference in its entirety.

### FIELD OF ART

This application relates generally to energy management and more particularly to energy transfer through fluid flows.

### BACKGROUND

The demand for energy worldwide is at this time increasing at an ever-accelerating rate. Some countries are actively engaged in both reducing their energy demands and revamping their energy infrastructures, while others are constructing fossil fuel burning power plants, nuclear facilities, hydro dams, and other controversial or traditional sources of energy generation. This continually increasing demand for energy is propelled by the growth of municipalities, counties, states, and countries, and the development of rural or previously underserved areas. The demand is further rooted in improved standards of living, and the ensuing increased use of household appliances and personal electronic devices. The increases in the living standards, particularly in rural areas, has required both the installation of electrical and communications infrastructures and the expansion of transportation networks. Growing populations cause a further increase in energy demand as more people consume energy for cooking, bathing, cleaning, laundry, and entertaining. Energy is additionally consumed for illuminating, heating, and cooling houses or apartments, businesses, and government buildings. Other increases in energy demand directly result from expanded economic activities including retail, public transportation, and manufacturing, among many others.

Government agencies, energy producers, and thrifty or responsible energy consumers are motivated to initiate, practice, and enforce energy conservation measures. Consumers can decrease their energy footprints by lowering the thermostat in winter or increasing the thermostat in summer; turning off lights when leaving a room; and purchasing energy-efficient appliances, electronic consumer products, and automobiles. Each of these simple tasks is a popular step toward reducing cost through energy conservation. While these and other concerted conservation efforts can help, the demand for energy of all types continues to increase beyond the savings which are solely attributable to conservation. The growth of towns, cities, states, and countries increases the demand for energy of all kinds, resulting in what many analysts identify as an energy crisis. Thus, increasing energy demand has many dimensions. Increased demand and overconsumption of energy has imposed strains on natural resources ranging from fossil fuels to renewables such as wood chips, resulting in fuel shortages and increased environmental destruction and pollution.

The distribution of energy from generation sources to sinks or loads has been identified as a persistent hindrance to solving the energy crisis. The existing energy distribution infrastructure is at capacity and often unavailable to potential new energy sources including renewable energy. Further, aging energy generation equipment is unable to provide for the increased energy demands. Renewable energy options remain largely unexplored or underdeveloped, and there is strong and vociferous resistance by adjacent landowners and others to siting of mountain or offshore windmills, solar farms, or wood burning plants. Even when designs can be drafted and permits obtained to construct renewable energy producing facilities, the distribution of the energy is impeded by the poor distribution infrastructure. Further, landowners are reluctant to agree to high tension lines that traverse their property, particularly when the power is destined for consumers “from away”. Commissioning of new energy generation facilities remains a seemingly insurmountable challenge. Legal wrangling, construction delays, pollution mitigation requirements, crushing costs, or even war, have prevented, halted, or delayed new energy generation facilities from coming online. Energy loss and wastage remain major impediments. Aging appliances or manufacturing equipment, incandescent light bulbs, and poor building insulation and air sealing, all waste energy in comparison to their modern counterparts.

To meet the many increases in energy demands, public officials at national, state, and local levels, plus city and regional planners, are compelled to decide among three broad energy solutions: to increase energy production by building new power plants, to reduce energy demand through energy conservation, or to implement a combination of both of these strategies. Another emerging energy production option is to implement energy generation based on renewable energy sources such as solar, wind, biofuels, geothermal, wave action, and so on. The primary limitation of many renewable energy sources remains that the sources do not produce consistent amounts of energy all day, every day. Solar energy only produces energy in the presence of light, and produces varying amounts of energy depending on the intensity of the light hitting photovoltaic panels. Wind energy only produces energy when the wind is blowing. Energy generation sources and energy consumption demands must be balanced so that clean, reliable, and consistent energy is available at all times to all consumers throughout the country.

### SUMMARY

Diverse and disparate energy generation sources can be used to produce energy such as electrical energy. Multiple generation sources are typically required at any given time in order to address differences in energy generation and energy demand. In addition, energy production and energy consumption differences typically increase or decrease over a given period of time. These differences can further depend on a given timeframe such as day versus night, day of the week, manufacturing or processing schedules, seasonal factors such as heating or cooling demands, and so on. The discrepancies between energy production and energy consumption can be considerable, and at times, highly mission critical. The discrepancies can correlate to time-dependent energy demands such as changeable energy production capabilities due to the availability of a renewable resource used to generate the energy, night time lighting, the capacity of commercial or grid power, the amount of standby or backup energy available, etc. This energy consumption/production imbalance can be addressed by energy storage, where available energy that exceeds demand at a given time is stored for later use. The stored energy can be accessed when demand exceeds a given level of available power. Further, renewable energy can be collected and stored when the renewable resource is available, when the available energy exceeds the needed energy, or even when the production cost of the energy is relatively inexpensive. The stored energy can be used to augment available energy or to provide the amount of energy that is needed during periods of increased or unmet energy requirement. The recovery of stored energy can be scaled. Stored energy recovery can be applied to low-level energy demand scenarios, such as the energy needs of a house or small farm operation, or to larger scale energy needs such as the energy needs for processing or manufacturing, or even to the largest energy requirements such as the energy needs for an energy distribution grid.

Disclosed techniques address energy transfer through fluid flows for energy management. Access to a fluid-based local energy transfer distribution network is obtained. One or more fluid-based energy storage and generation assemblies are connected to the fluid-based local energy transfer distribution network. Energy is provided to the one or more fluid-based energy storage and generation assemblies. Fluid-based energy from the energy storage and generation assemblies is delivered to the fluid-based local energy transfer distribution network, where the delivering is based on an energy control management system executing on one or more processors. The delivering includes providing local, fluid-based services.

A computer-implemented method for energy management is disclosed comprising: obtaining access to a fluid-based local energy transfer distribution network; connecting one or more fluid-based energy storage and generation assemblies to the fluid-based local energy transfer distribution network; providing energy to the one or more fluid-based energy storage and generation assemblies; and delivering fluid-based energy from the energy storage and generation assemblies to the fluid-based local energy transfer distribution network, wherein the delivering is based on an energy control management system executing on one or more processors. In embodiments, the delivering includes providing local, fluid-based services. In embodiments, the local, fluid-based services supply local consumer applications, and the local consumer applications include a water nozzle, an air nozzle, a water Venturi function, an air Venturi function, a vacuum supply, space heating, a fluid-based rotation, space cooling, hot water, or cold water. In some embodiments, the delivering includes providing a fluid-based equivalent mechanical range of motion through fluid transfer. And in some embodiments, the energy storage and generation assemblies comprise multiple, parallel pipes to accommodate fluid expansion or compression.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for energy management using energy transfer through fluid flows for energy management.

FIG. 2 is a block diagram related to fluid-based energy.

FIG. 3 is a block diagram for energy management.

FIG. 4 illustrates an energy internet block diagram.

FIG. 5 shows a software-defined water piston heat engine (WPHE).

FIG. 6 illustrates energy storage and recovery.

FIG. 7 shows fluid-based energy transfer.

FIG. 8 illustrates fluid-based pump energy input/output.

FIG. 9 shows piping for pressure storage in hierarchies.

FIG. 10A illustrates adiabicity in a heat transfer cycle.

FIG. 10B illustrates an isothermal heat transfer cycle.

FIG. 11 is a system diagram for energy management using a fluid-based infrastructure.

### DETAILED DESCRIPTION

This disclosure provides techniques for energy management using energy transfer through fluid flows. Various types of fluids can be used for energy transfer. The fluids can include water, a specialized fluid such as Freon™, and so on. The energy transfer can be accomplished using a homogeneous fluid, heterogeneous fluids, etc. The energy transfer can be accomplished using multiple phases such as liquid and gas phases. One or more fluid-based energy storage and generation assemblies are connected to the fluid-based local energy transfer distribution network. The energy storage and generation assemblies can include multiple, parallel pipes to accommodate fluid expansion or compression. The multiple, parallel pipes can be of substantially similar sizes or different sizes. The multiple, parallel pipes can be organized into structures such as hierarchical structures. The fluid-based energy storage and generation assemblies can be controlled to implement various functions. The controlling can include controlling the one or more fluid-based energy storage and generation assemblies to implement a compressor function, an expander function, or a heat exchanger function. The fluid-based energy storage and generation assemblies each comprise a pump-turbine and a pressure vessel. At least one of the one or more fluid-based energy storage and generation assemblies can include a pump running at an optimum performance-pressure point. The fluid-based energy storage and generation assemblies can be components of a large-scale energy storage subsystem which can store energy from one or more points of generation.

Energy is provided to the one or more fluid-based energy storage and generation assemblies. The provided energy can be stored. The energy that is stored can be received from widely diverse and disparate energy sources. Energy can be stored when the amount of energy available from the points of generation exceeds the energy demand at the time of energy generation. The energy can be stored for a period of time. The energy storage can include fluid-based energy storage. The energy storage can include electrical energy storage using batteries or capacitors. The stored energy can be provided after a period of time to meet energy demands of current loads, dynamic loads, seasonal loads, and the like. Fluid-based energy from the energy storage and generation assemblies is delivered to the fluid-based local energy transfer distribution network, where the delivering is based on an energy control management system executing on one or more processors. Managing the obtaining, connecting, providing, and delivering of energy is a complex and highly challenging task. Energy management can be influenced by many factors such as seasonal factors including the weather, variable energy generation pricing schemes, wildly varying energy demand, and so on. Energy management can be further complicated by an expanding energy customer base, quickly changing customer energy demands, requirements of service level agreements (SLAs), energy policies, etc. Despite the growing use of renewable energy resources such as solar, wind, wave action, tidal, geothermal, biogas, and the like, two significant challenges remain: the amount of energy produced by a given renewable energy source is highly variable, and the availability of the renewable energy source is inconsistent. As an example, wind energy is only available when wind is present, solar energy only when the sun is shining, wave action energy only when there is wave action, and so on.

Energy with intermittent availability or energy in excess of present load requirements can be stored or cached when the energy is being produced, and can be extracted and used for energy generation at a later time when the stored energy is needed. A similar strategy can be used based on price, where energy is stored when production cost is low, then later extracted when the energy production cost is high. The stored energy can be used in combination with other energy sources such as grid power or microgrid (local) power to meet energy demands at given times. Storage can include a period of time, where the period of time can be a short-term basis or a long-term basis. Energy losses are introduced when converting energy from one energy type to another energy type. Further losses occur when storing energy, extracting energy, generating energy, routing energy, etc. Minimizing the energy losses is critical to any energy storage and retrieval/recovery technique. Electrical energy storage is possible using techniques such as mature storage battery technologies, but the high costs of large battery banks are prohibitive in terms of up-front investment and maintenance expenses. Further, batteries are problematic for long-term storage purposes because of charge leakage.

In disclosed techniques, energy management uses energy transfer through fluid flows. Energy can be obtained locally from a microgrid or farther afield using a grid. The energy can be derived from conventionally generated sources, renewable sources, etc., and can be stored. The stored energy can be used for energy generation at a later time. The energy can be generated using fuels such as coal, natural gas, or nuclear sources; using hydro power or geothermal energy; using renewable sources such as solar, wind, tidal, wave-action, bio-fuels or biogas; using pump-turbine sources such as compressed air, steam, or ice; or using backup power sources such as diesel-generator (DG) sets; and so on. Access to a fluid-based local energy transfer distribution network is obtained. The energy transfer distribution can be based on one or more fluids, where the fluids can include water, liquid air, a specialty liquid such as Freon™, etc. The fluid-based local energy transfer distribution network can include at least two heterogeneous fluids. The energy transfer within the local energy transfer distribution network can be accomplished using multiple phases. The fluid-based local energy transfer distribution network can include a homogeneous fluid in liquid and gaseous phases.

One or more fluid-based energy storage and generation assemblies are connected to the fluid-based local energy transfer distribution network. The energy storage and generation assemblies can include multiple, parallel pipes to accommodate fluid expansion or compression. The multiple, parallel pipes can be organized into a hierarchy of parallel pipes. The energy storage and generation assemblies can include a pump-turbine and a pressure vessel. At least one of the one or more fluid-based energy storage and generation assemblies can include a pump running at an optimum performance-pressure point. The fluid-based energy storage and generation assemblies can be parts of a larger energy management system that can include a large-scale energy storage subsystem. The large-scale energy storage subsystem can store electrical energy, potential energy, thermal energy, kinetic energy, chemical energy, etc. Energy is provided to the one or more fluid-based energy storage and generation assemblies. The energy that is provided can include grid energy, microgrid energy, renewable energy, and so on. The providing the energy can be controlled by an energy control management system. The energy control management system can control fluid connections within the one or more fluid-based energy storage and generation assemblies. The controlling of the fluid connections can be accomplished with a flow controller module. The flow controller module can activate or disable pumps, open or close valves, etc. The controlling fluid connections can be performed by electrically controlled valves. The energy can be provided by actuating one or more valves.

Fluid-based energy from the energy storage and generation assemblies is delivered to the fluid-based local energy transfer distribution network. The delivering is based on an energy control management system executing on one or more processors. The delivering can include providing local fluid-based services, where the local fluid-based services supply local consumer applications. The consumer application can include a water nozzle, an air nozzle, a water Venturi function, an air Venturi function, a vacuum supply, space heating, a fluid-based rotation, space cooling, hot water, or cold water. The energy control management system uses supply profiles and demand profiles to adjust the delivering. The energy control management system provides valve control information to the one or more fluid-based energy storage and generation assemblies. The obtaining, the connecting, the providing, and the delivering comprise an energy internet converged infrastructure.

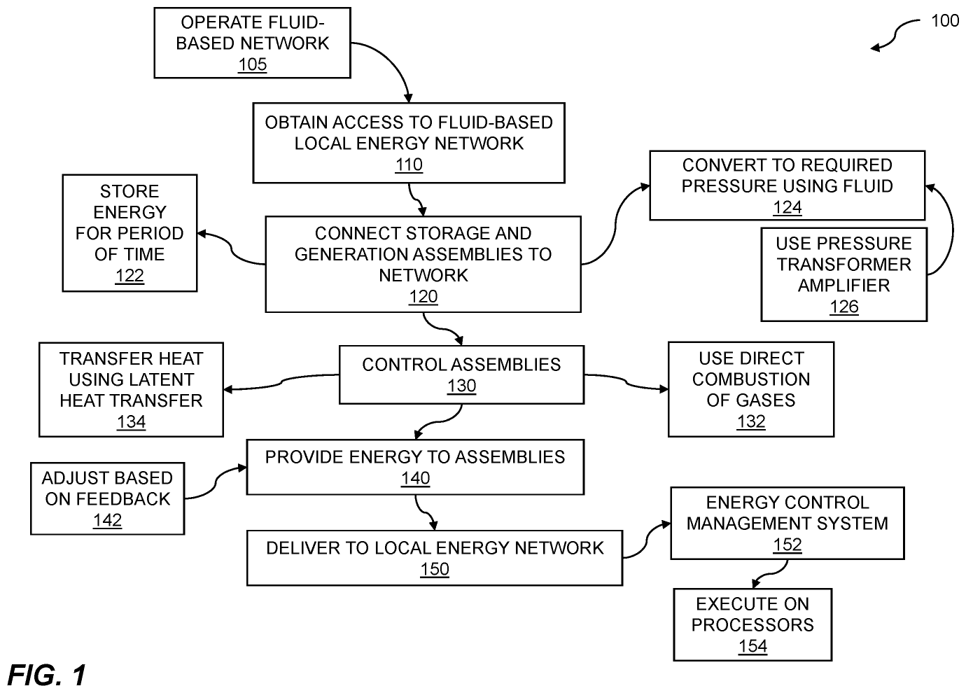

FIG. 1 is a flow diagram for energy management using energy transfer through fluid flows. Energy storage and management can be based on one or more assemblies, where the one or more assemblies can include fluid-based energy storage and generation assemblies. The fluid-based energy storage and generation assembly can include multiple, parallel pipes to accommodate fluid expansion or compression. The fluid can include water, liquid air, liquid nitrogen, and the like. The fluid can be used to compress a gas such as air or nitrogen, a specialty gas such as Freon™, and so on. The fluid can be used to move a liquid, such as by using the fluid to spin a pump-turbine. The pump-turbine can be used to move the liquid to create hydraulic head. The fluid in which energy is stored can be used to generate energy. The fluid can be used to spin a turbine, the pump-turbine, and the like. The fluid-based energy can include hot air, liquid air, cold air, or vacuum services. The fluid-based energy storage and generation assemblies can be parts of a large energy storage and generation subsystem. The energy storage and generation subsystem can include further assemblies for storing energy in other forms. The further energy storage and generation subsystems can include multiple batteries or capacitors, pressurized storage elements such as high-pressure water, pressurized air, steam, ice-water slurry, and the like.

Access to a fluid-based local energy transfer distribution network is obtained. The distribution network can include pipes within which fluids, gases, or phases (e.g. fluid and gas) can be contained. One or more fluid-based energy storage and generation assemblies are connected to the fluid-based local energy transfer distribution network. In embodiments, the energy storage and generation assemblies can include multiple, parallel pipes to accommodate fluid expansion or compression. The parallel pipes can include pipes with substantially similar dimensions or pipes with substantially dissimilar dimensions. The parallel pipes can be organized in various configurations. In embodiments, the multiple, parallel pipes are configured in a hierarchy. The hierarchy can include ratios between pipes within the hierarchy. In embodiments, the hierarchy can include 2-to-1 piping for compression or 1-to-2 piping for expansion. The hierarchy can include various levels of hierarchy. In embodiments, the hierarchy comprises no more than seven levels to achieve at least 100 times pressure expansion or contraction. Energy is provided to the one or more fluid-based energy storage and generation assemblies. The energy can be provided from grid energy, renewable energy, and the like. Fluid-based energy from the energy storage and generation assemblies is delivered to the fluid-based local energy transfer distribution network, where the delivering is based on an energy control management system executing on one or more processors. The delivering can include providing local fluid-based services. The delivering can include providing a fluid-based equivalent mechanical range of motion through fluid transfer.

A flow 100 for energy management using energy transfer through fluid flows is shown. The fluid flows can be accomplished using multiple, parallel pipes. The pipes can be used to accommodate fluid expansion or compression. Energy, such as electrical energy obtained from a traditional electrical grid, energy from renewable sources, locally generated energy, gas or diesel generated electrical energy, and so on, can be stored and used for energy generation. Other forms of energy including thermal energy, mechanical energy, kinetic energy, pressure, etc. can be stored. The energy can be transformed into an energy format which can be stored for a length of time, where the length of time can include a short-term basis, a long-term basis, etc. Energy management can be based on one or more energy control policies, energy production costs, service level agreements, energy needs, and the like. An energy management policy can be used for storing, retrieving, generating, or extracting energy from an energy storage assembly. The energy storage assembly can be a large-scale energy storage assembly or can be a small-scale energy storage assembly.

The flow 100 includes operating a fluid-based energy transfer distribution network 105. Described below, the fluid-based energy transfer distribution network can use one or more fluids or one or more phases (e.g. liquid, gas) for energy transfer. While fluid-based energy storage and generation assemblies are discussed throughout, the energy storage assemblies further can be based on battery storage, capacitor storage, inductive storage, compressed air storage, steam or ice storage, ice-water slurry, and so on. Storage can include use of chemical, methane, or some other type of storage. While energy storage and generation assemblies comprising multiple, parallel pipes are described, the energy storage assemblies can include a pump-turbine and pressure vessel assembly. The pressure vessel can include energy storage elements such as high-pressure chambers, compression-expansion chambers, compressed air chambers, and so on. The pressure vessels can be located above ground, below ground, submerged in water, etc. The pressure vessels can include unused oil infrastructure such as unused or non-productive oil well infrastructure, unused salt caverns, aquifers, large cavities underground, or porous rock structures capable of holding air or water under pressure. The storage elements of an energy storage and generation assembly can store various types of energy including electrical energy, thermal energy, kinetic energy, mechanical energy, hydraulic energy, and so on.

The flow 100 includes obtaining access to a fluid-based local energy transfer distribution network 110. The local energy transfer distribution network can include pipes of various dimensions. Fluids can be moved into the pipes, out of the pipes, through the pipes, and so on. A pump-turbine can be used for moving fluid through the local energy transfer distribution network. The pump-turbine can include a pump-turbine subassembly or a pump subassembly and a turbine subassembly. The pump-turbine can consume energy such as electrical energy to spin the turbine. The pump-turbine can be used to move a fluid such as water, liquid air, liquid nitrogen, and so on, where the water or other fluid can be used to pressurize the pressure vessel. The fluid, gas, etc. can spin the turbine of the pump-turbine, which in turn can spin the pump. In embodiments, the pump can be used to generate energy such as electrical energy. In embodiments, the pump-turbine can be used to convert energy such as electrical energy to a fluid-based energy that can be stored. The fluid-based energy can include pressure, flow, hydraulic head, etc. In embodiments, the fluid of the one or more fluid-based energy storage and generation assemblies can include liquid air. The fluid can further include water such as ambient water, treated water, etc.

The flow 100 includes connecting one or more fluid-based energy storage and generation assemblies to the fluid-based local energy transfer distribution network 120. The fluid-based local energy transfer distribution network can be part of an energy transfer distribution system. In embodiments, the local energy transfer distribution system can include a microgrid. Various types of fluid-based energy storage and generation assemblies can be used. In embodiments, the energy storage and generation assemblies can include multiple, parallel pipes to accommodate fluid expansion or compression. The multiple, parallel pipes can include dimensions that are substantially similar or substantially different. Fluid expansion or compression within the multiple, parallel pipes can be accomplished using a pump, a pump-turbine, etc. In embodiments, the one or more fluid-based energy storage and generation assemblies include storing energy for a period of time 122. The period of time for which the energy can be stored can be based on a variety of factors such as when or where the energy is produced, by what means the energy is produced, a possible use for the energy, and the like. In embodiments, the period of time can be a short-term basis. Storing energy for a short-term basis can include storing energy as electrical energy in capacitors, chemical energy in batteries, etc. The storing energy for a short-term basis can include storing energy using a fluid-based energy storage and generation assembly. In embodiments, the short-term basis can be an integer number of seconds, minutes, hours, or days, where the integer number of seconds, minutes, hours, or days comprises a length of time substantially less than one week. The energy storage can include other periods of time. In embodiments, the period of time is a long-term basis. A long-term basis can include storing energy such as thermal energy collected during hot months for use during cold months. In embodiments, the long-term basis can be an integer number of weeks, months, seasons, or years, wherein the integer number of weeks, months, seasons, or years comprises a length of time substantially more than one day.

In embodiments, at least one of the one or more fluid-based energy storage and generation assemblies includes a pump running at an optimum performance-pressure point. The pump can include a standalone pump, a pump-turbine, and so on. The optimum performance-pressure point can be determined by design, by monitoring pump performance during operation, and so on. Further embodiments include converting the pump optimum performance-pressure point pressure to a required pressure within the fluid-based local energy transfer distribution system 124. An optimum performance-pressure point pressure of a given pump may be different from a fluid pressure required for storing energy. The optimum performance-pressure point pressure can be converted. In embodiments, optimum performance-pressure point pressure is converted using a pressure transformer amplifier 126. Pressure conversion can be accomplished using a variety of techniques. In embodiments, the pressure transformer amplifier uses two or more pressure amplification pipes.

The one or more fluid-based energy storage and generation assemblies can be controlled. The controlling of the assemblies can include software control. The software control can be used to implement a variety of functions. The flow 100 further includes controlling the one or more fluid-based energy storage and generation assemblies 130. The controlling can be used to implement various functions. In embodiments, the controlling can implement a compressor function, an expander function, or a heat exchanger function. The controlling can include adding heat to prevent freezing during expansion, extracting heat to provide cooling during compression, and so on. In the flow 100, the controlling can provide heat during expansion through direct combustion of a gas 132. The gas can include natural gas, propane, butane, biogas, and so on. In embodiments, the heat exchanger function can enable recovering waste heat through a waste-heat recovery subsystem. The recovering waste heat can occur during compression. In the flow 100, the controlling can transfer heat using latent heat transfer 134. The latent heat transfer can include capturing heat released during a change of phase. A change of phase can include changing a liquid such as water to a gas such as water vapor or steam. In other embodiments, the controlling provides a cold water spray to provide cooling during compression. To counteract cooling during expansion, the control can include various techniques. In embodiments, the controlling provides a hot water spray to add heat during expansion. Under certain usage conditions, the heat introduced by the hot water spray may not provide enough thermal energy to counteract the cooling effect of expansion such as rapid or prolonged expansion. Between cooling and heating, a fluid temperature can be maintained. In embodiments, the controlling enables isothermal operation of the one or more fluid-based energy storage and generation assemblies.

The flow 100 includes providing energy to the one or more fluid-based energy storage and generation assemblies 140. The energy that is provided can include fluid energy, chemical energy, mechanical energy, kinetic energy, and so on. In embodiments, the providing includes using electrical energy. The electrical energy can be used to drive a pump, a pump-turbine, etc. The electrical energy that is provided can include grid energy, microgrid (locally generated) energy, renewable energy, and the like. The amount of energy that can be provided to the one or more fluid-based energy storage and generation assemblies can vary due to an amount of available energy, available energy sources, energy loads, etc. Further embodiments include adjusting the providing based on feedback 142 to the energy control management system. The feedback can include data such as status data, operating data, etc. Status data can include pressure levels, electrical charge levels, and the like. Operating data can include status of the one or more fluid-based energy storage and generation assemblies, maintenance data, offline data, and so on. In embodiments, the feedback includes energy supply or energy demand updates. The energy supply or energy demand updates can be supplied automatically, can be based on service level agreements, can include seasonal adjustments, etc. The load information can be based on instantaneous load (dL/dt), estimated load, seasonally adjusted load, weather-based factors, and the like. The load information can be articulated in a service level agreement (SLA) in which a level of electrical energy delivery is required. In embodiments, the energy control management system is driven by an energy control policy. The energy control policy can be based on cost of energy production, mean time to failure (MTTF) predictions for assemblies within the energy storage and generation subsystem, contractual obligations for levels of energy delivery, etc. In embodiments, the energy control policy changes dynamically. The dynamic changes to the energy control policy can be based on equipment failure, unanticipated load requirements, emergency situations such as a natural disaster or emergency maintenance, etc.

The flow 100 includes delivering fluid-based energy from the energy storage and generation assemblies to the fluid-based local energy transfer distribution network 150. The fluid-based energy can be delivered using a variety of delivery techniques. In embodiments, the delivering includes providing local fluid-based services. The local fluid-based services can include domestic services, commercial or manufacturing services, governmental services, and the like. In embodiments, the local, fluid-based services can supply local consumer applications. Various types of fluid-based services can be supplied. In embodiments, the local, consumer applications can include a water nozzle, an air nozzle, a water Venturi function, an air Venturi function, a vacuum supply, space heating, a fluid-based rotation, space cooling, hot water, or cold water. The delivering can provide other functions or services. In embodiments, the delivering can include providing a fluid-based equivalent mechanical range of motion through fluid transfer. The fluid-based equivalent mechanical range of motion can include operating an activator, pushing or pulling a piston, controlling valves, controlling flow such as fluid flow, etc. In a usage example, the fluid flow for mechanical or machine range of motion can replace mechanical systems, such as mechanical valves that can be driven by one or more motors such as an electrical motors, with software controlled apparatuses based on fluid flow. In embodiments, the equivalent mechanical range of motion can control fluid mixing. The rate of fluid flow can be adjusted. In further embodiments, the equivalent mechanical range of motion can control fluid velocity. Other fluid parameters can be controlled by the equivalent mechanical range of motion. In other embodiments, the equivalent mechanical range of motion can control fluid rotation. As discussed throughout, delivering energy by the fluid-based local energy transfer distribution network can be controlled.

In the flow 100, the delivering is based on an energy control management system 152. The energy control management system can be software controlled. In embodiments, the energy control management system can use supply profiles and demand profiles to adjust the delivering. The energy control management system can respond to real-time operating data. The energy control management system can use one or more service level agreements. In embodiments, the energy control management system controls electrical connections between the one or more fluid-based energy storage and generation assemblies and the energy grid. The electrical grid can include a micro-grid or onsite grid, a local grid, a regional grid, a national grid, and so on. In embodiments, the energy control management system can be driven by an energy control policy. The energy control policy can include policies based on energy availability, energy demands, seasonal adjustments, energy use priorities, etc. The energy control policy can be static, determined by agreement such as a service level agreement, and so on. In embodiments, the energy control policy changes dynamically. The flow 100 includes executing on one or more processors 154. The processors can include electronic controllers, microcontrollers, microcomputers, servers, and the like. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

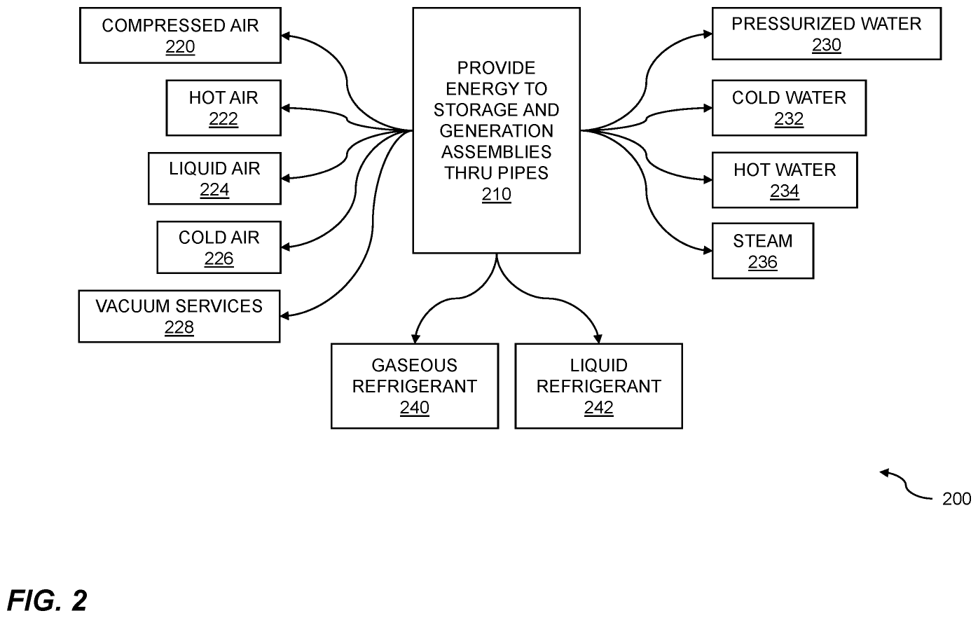

FIG. 2 is a block diagram related to fluid-based energy. Discussed throughout, energy storage and generation assemblies, such as fluid-based energy storage and generation assemblies, can be used to convert various types of energy such as grid energy or renewable energy into a storage format which can be used for later energy generation and use. The energy that can be stored can include excess energy, intermittent energy, etc. The latter use can include providing energy to meet excess demand, to reduce energy production cost, and so on. Access to a fluid-based local energy transfer distribution network is obtained. One or more fluid-based energy storage and generation assemblies are connected to the fluid-based local energy transfer distribution network. Energy is provided to the one or more fluid-based energy storage and generation assemblies. Fluid-based energy from the energy storage and generation assemblies is delivered to the fluid-based local energy transfer distribution network, where the delivering is based on an energy control management system executing on one or more processors.

Described throughout, the one or more fluid-based energy storage and generation assemblies can be controlled in order to implement various functions. In embodiments, the functions can include a compressor function, an expander function, or a heat exchanger function. Other functions may also be implemented. The compressor function can generate heat due to heating of a gas or a liquid as a result of the compression. The expander function can absorb heat based on cooling of the gas or the liquid as a result of the expansion. The heat exchanger function can capture or remove the heat from compression or can provide or inject heat during cooling. In embodiments, the controlling can enable isothermal operation of the one or more fluid-based energy storage and generation assemblies. The heat that can be transferred to or removed from the one or more fluid-based energy storage and generation assemblies can be based on latent heat transfer. Latent heat can be an amount of heat provided to or removed from the one or more fluid-based energy storage and generation assemblies during a phase change that can occur within the assemblies. The phase change can include evaporation of a liquid, deposition of a gas, etc.

The flow 200 includes providing energy to the one or more fluid-based energy storage and generation assemblies. The providing energy to the one or more fluid-based energy storage and generation assemblies can be accomplished using pipes 210. In embodiments, the energy storage and generation assemblies comprise multiple parallel pipes to accommodate fluid expansion or compression. The pipes can be of substantially similar dimensions or of substantially dissimilar dimensions. The pipes can be organized into various structures convenient to energy storage and generation. In embodiments, the multiple parallel pipes are configured in a hierarchy. The hierarchy can be organized or scaled to perform operations on the fluid or fluids within the pipes. In embodiments, the hierarchy can include 2-to-1 piping for compression or 1-to-2 piping for expansion. The hierarchy can include two or more levels or layers. In embodiments, the hierarchy can include no more than seven levels to achieve at least 100 times pressure expansion or contraction.

The fluid-based energy storage and generation assemblies can store and generate energy based on one or more liquids, gases, phases, and the like. The flow 200 includes the fluid-based energy compressed air 220. The compressed air can be provided by a pump-turbine, retrieved from an air compression tank, and so on. The compressed air can be maintained at a given temperature or can be permitted to heat under compression, cool under expansion, etc. In the flow 200, the fluid-based energy comprises hot air 222. The hot air can be created by heating based on combustion of gases such as natural gas, propane, butane, or biogas; compression of the air by a pump-turbine, and the like. In embodiments, the hot air can be supplied to the distribution network at a temperature greater than ambient air temperature. In the flow 200, the fluid-based energy comprises liquid air 224. The liquid air can be provided at a temperature below which the constituents of gaseous air condense. In embodiments, the liquid air is supplied to the distribution network at a temperature less than −215° C.

In the flow 200, the fluid-based energy includes cold air 226. The cold air can be generated by removing thermal energy from air. The temperature of the cold air can include a range of values. In embodiments, the cold air is supplied to the distribution network at a temperature less than ambient air temperature. In the flow 200, the fluid-based energy includes vacuum services 228. The vacuum can be generated by pumping or other techniques. An amount of vacuum can be chosen for fluid-based energy purposes. In embodiments, the vacuum services are supplied to the distribution network at a pressure of less than 14 pounds per square inch vacuum (PSIV). In the flow 200, the fluid-based energy includes pressurized water 230. The pressurized water can be generated by pumping, by creating hydraulic head, and the like. In embodiments, the pressurized water is supplied to the distribution network at a pressure of more than one bar.

Energy can be provided to the one or more fluid-based energy storage and generation assemblies based on latent heat transfer. In embodiments, controlling enables isothermal operation of the one or more fluid-based energy storage and generation assemblies. As explained throughout, isothermal operation can include an adiabicity of near-zero. The latent heat transfer can be controlled. In the flow 200, the controlling provides a cold water spray to provide cooling during compression 232. The cold water which can be used to provide the cold water spray can be cold water stored from an expansion of a liquid or gas. The cold water can be generated as needed for cooling purposes. In embodiments, the latent heat transfer can be provided using an ice-to-water transition. As heat is added to the ice, the ice melts to form water. During the melting process, the temperature of the ice-water remains constant. In the flow 200, the controlling provides a hot water spray to add heat during expansion 234. The hot water spray can be generated from stored heat captured from a compression of a liquid or gas. The hot water spray can be generated as needed by burning a fuel. In embodiments, the controlling can provide heat during expansion through combustion of a gas. The gas can include natural gas, biogas, etc. In the flow 200, the latent heat transfer can be provided using a water-to-steam transition 236. Latent heat is absorbed by the water as the water evaporates to form steam. The steam can be generated from water based on providing stored energy, combusting a gas, and the like. In the flow 200, the providing energy to the one or more fluid-based energy storage and generation assemblies is based on a gaseous refrigerant 240. Various gaseous refrigerants can be used, such as ammonia, carbon dioxide, non-halogenated hydrocarbons, propane, etc. In the flow 200, the providing energy to the one or more fluid-based energy storage and generation assemblies is based on a liquid refrigerant 242. Various liquid refrigerants can be used. The liquid refrigerants can include specialty liquids such as Freon™ In further embodiments, the latent heat transfer is provided using a transition from a gas refrigerant to a liquid refrigerant.

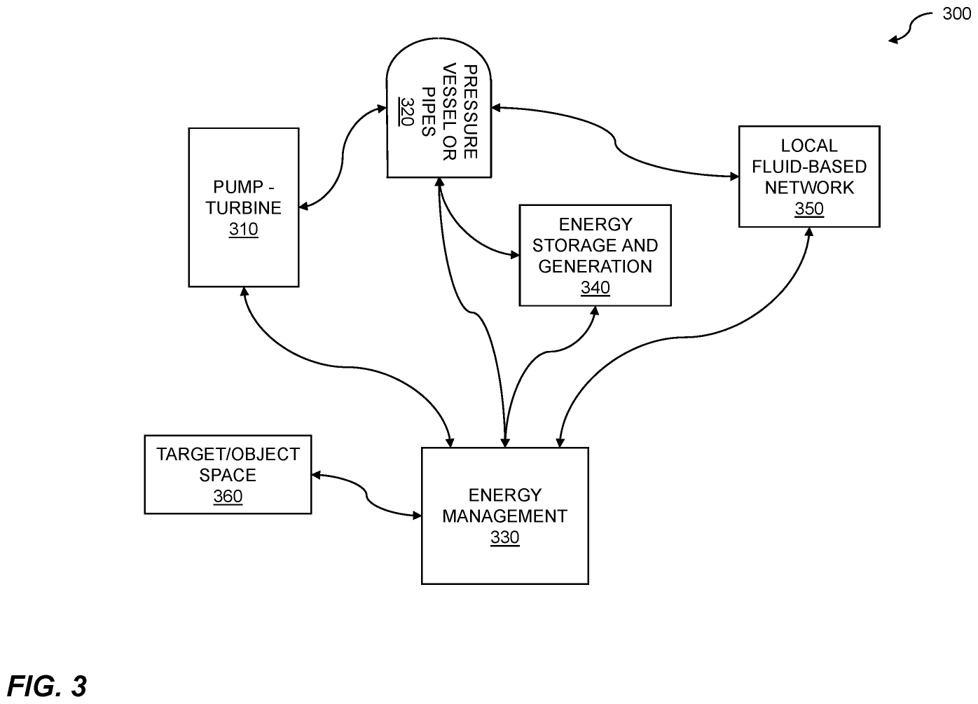

FIG. 3 is a block diagram for energy management. Energy management can be based on energy transfer through fluid flows. The converged infrastructure can include fluid-based assemblies for energy storage and generation. Access to a fluid-based local energy transfer distribution network is obtained. One or more fluid-based energy storage and generation assemblies are connected to the fluid-based local energy transfer distribution network. Energy is provided to the one or more fluid-based energy storage and generation assemblies. Fluid-based energy from the energy storage and generation assemblies is delivered to the fluid-based local energy transfer distribution network. The delivering is based on an energy control management system executing on one or more processors.

Energy management 300 can include a pump-turbine 310. In embodiments, the pump-turbine can comprise separate pump and turbine components, a combined pump-turbine component, etc. The pump-turbine can be coupled to a vessel. The vessel can comprise a pressure vessel or pressure pipes 320. Energy management can include more than one pump-turbine/pressure vessel or pressure pipes assembly. The pressure vessel can include an air compression tank, a cavern, unused oil infrastructure, and so on. The pressure pipes can include pressure amplification pipes.

The pump-turbine/pressure vessel or pipes assembly can be connected to an energy management component 330. The energy management component can include an energy control management system, where the energy control management system can include software that can be executed on one or more processors. The energy management component can be coupled to energy storage and generation 340. Various types of energy, such as electrical energy, chemical energy, thermal energy, kinetic energy, potential energy, etc., can be stored. Energy storage such as electrical energy storage can include batteries, capacitors, and so on. Fluid-based energy storage and generation assemblies can include multiple parallel pipes to accommodate fluid expansion or compression. The energy management can control the pump of the pump-turbine. In embodiments, at least one of the one or more fluid-based energy storage and generation assemblies includes a pump running at an optimum performance-pressure point. Other energy storage techniques can be used. When the energy being stored is electrical energy, the electrical energy can be converted between direct current (DC) electrical energy and alternating current (AC) electrical energy. Energy storage can be accomplished using flywheels which can be separate from or included as part of a motor or generator.

The energy management can include a local fluid-based network 350. The fluid-based network can include energy management, energy storage and generation, pressure vessels or pressure pipes, pump-turbines, and so on. The local fluid-based network can be used for delivering fluid-based energy. In embodiments, the delivering includes providing local, fluid-based services. The fluid-based services can include domestic services, industrial or manufacturing services, and the like. In embodiments, the local, consumer applications can include a water nozzle, an air nozzle, a water Venturi function, an air Venturi function, a vacuum supply, space heating, a fluid-based rotation, space cooling, hot water, or cold water. The delivering can provide other services such as motion services. In embodiments, the delivering includes providing a fluid-based equivalent mechanical range of motion through fluid transfer. The energy management can include a target/object space 360.

Fluid-based energy transfer can include conveying a fluid flow to a target object or target space. The conveyance of the fluid flow can be accomplished using ducts, pipes, Venturi functions, nozzles, and so on. In embodiments, the conveyance can include two-phase heterogeneous or two-phase homogeneous compression. A pump or pump-turbine can be used to pressurize water for example, where the pressurized water can be used to compress air or other gas. The pump or pump-turbine can be used to compress air or a gas, where the pressurized air or gas can be used to pressurize a liquid such as water.

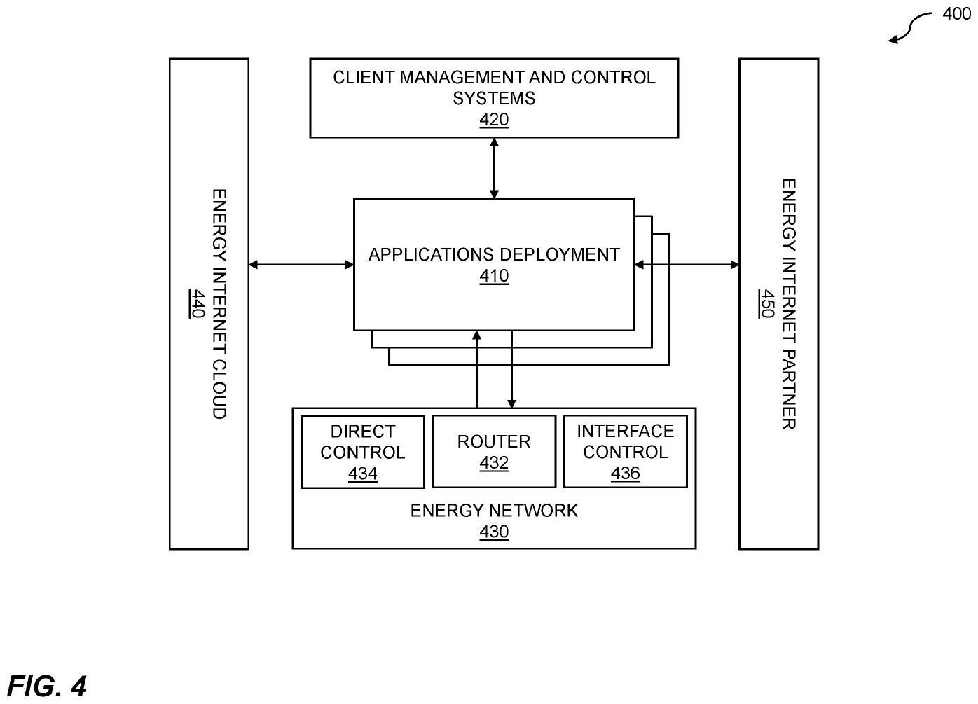

FIG. 4 illustrates an energy internet block diagram. An energy internet 400 enables energy management, where the energy management can be accomplished using a converged infrastructure. Energy management is further based on energy transfer through fluid flows. Access to a fluid-based local energy transfer distribution network is obtained. One or more fluid-based energy storage and generation assemblies are connected to the fluid-based local energy transfer distribution network. Energy is provided to the one or more fluid-based energy storage and generation assemblies. Fluid-based energy from the energy storage and generation assemblies is delivered to the fluid-based local energy transfer distribution network. The delivering is based on an energy control management system executing on one or more processors. The energy internet can include applications deployment 410. The applications deployment for an energy internet can include a cluster, where the cluster includes one or more application programming interfaces (APIs) for handling data, policies, communications, control, and so on. The data can include energy storage, pump-turbine storage, energy from water power, grid energy, etc. The data can include information from energy generators, partners, and so on. The data can further include third-party data from parties including energy consumers such as oil rigs; solar, wind, tidal, or wave-action farms; data centers; and the like.

Applications deployment can communicate with client management and control systems 420. The management can include infrastructure management, microgrid management, operating management, automated controls, and so on. The management can include management of client legacy equipment. The communicating of applications deployment with client management and control systems can include collecting data from one or more points of energy generation, one or more points of energy load, etc. The communicating can further include sending one or more energy control policies. The energy control policies can be based on the energy, energy information, energy metadata, availability of a large-scale energy storage subsystem, and the like. The energy internet can include an energy network 430. The energy network can include one or more energy routers 432, direct control 434, interface control 436, and so on. An energy router 432 can include digital switches for routing energy from a point of energy generation to a point of energy load. An energy router can be coupled to one or more direct control 434 sensors for detecting switch status, point of source status, point of load status, etc. An energy router can be coupled to direct control actuators for steering energy from one or more points of source to a given point of load. An energy router can be further connected to one or more third-party interface control 436 sensors and third-party interface control actuators. The interface control sensors and interface control actuators can be coupled to equipment such as legacy equipment which may not be directly controllable.

The energy internet (EI) can include an energy internet cloud 440. The energy internet cloud can include an energy internet ecosystem, an energy internet catalog, and so on. The energy internet cloud can include an energy internet secure application programming interface (API) through which the EI cloud can be accessed. The EI ecosystem can include third-party applications such as an application or app store, app development and test techniques, collaboration, assistance, security, and so on. The EI cloud can include an EI catalog. The EI catalog can include technology models, plant and equipment information, sensor and actuator data, operation patterns, etc. The EI cloud can include tools or “as a service” applications such as learning and training, simulation, remote operation, and the like. The energy internet can include energy internet partners 450. The EI partners can provide a variety of support techniques including remote management, cloud support, cloud applications, learning, and so on.

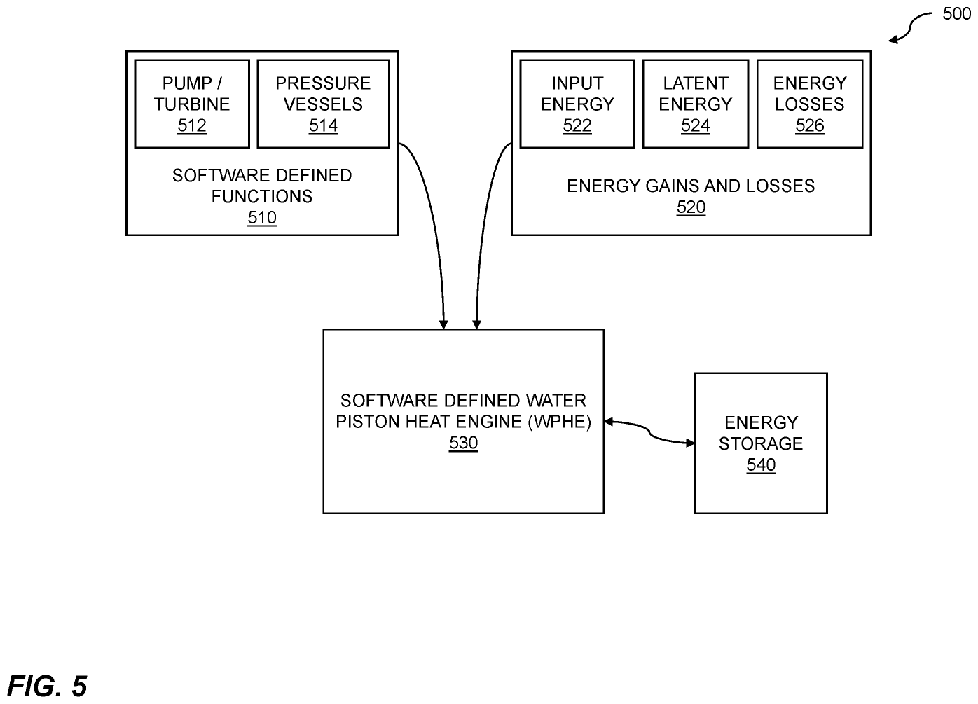

FIG. 5 shows a software-defined water piston heat engine. Energy can be generated, stored, recovered, transformed, delivered, and so on, to meet energy load requirements. Energy storage can be performed when a surplus of energy is being generated from energy sources including renewable energy sources such as wind, solar, tidal, wave-action, and so on. The energy can be stored on a short-term basis, such as a length of time substantially less than one week, or on a long-term basis, such as a length of time substantially more than one day. The energy transforming and delivering can be used for energy transfer through fluid flows for energy management. Access to a fluid-based local energy transfer distribution network is obtained. One or more fluid-based energy storage and generation assemblies are connected to the fluid-based local energy transfer distribution network. Energy is provided to the one or more fluid-based energy storage and generation assemblies. Fluid-based energy from the energy storage and generation assemblies is delivered to the fluid-based local energy transfer distribution network, where the delivering is based on an energy control management system executing on one or more processors. In embodiments, the delivering includes providing local, fluid-based services, where the local, fluid-based services supply local consumer applications. The local consumer applications include a water nozzle, an air nozzle, a water Venturi function, an air Venturi function, a vacuum supply, space heating, a fluid-based rotation, space cooling, hot water, or cold water.

A software-defined water piston heat engine system 500 is shown. The water piston heat engine includes one or more software-defined functions 510. The one or more software-defined functions can configure or control energy management system components, subsystem components, etc. The software-defined functions can include a pump-turbine function 512. The pump-turbine function can be used to control components such as one or more pumps, one or more turbines, and so on. The pump-turbine function can include one or more pump-turbine subsystems. Embodiments include operating the pump-turbine subsystem at an optimal pressure-performance point for the pump-turbine subsystem. An optimum pressure-performance point can be determined using one or more processors. The pump-turbine function can comprise physical components, moving components, etc. The software-defined functions can include one or more pressure vessels 514. The one or more pressure vessels can be used to store energy within a pressurized fluid, a pressurized gas, and the like. The one or more pressure vessels can include above-ground tanks, below-ground tanks, caverns such as salt caverns, unused oil infrastructure such as unused oil wells, etc.

The water piston heat engine can include energy gains and losses 520. Energy gains can include input energy 522. The input energy can include energy that can be input for storage. The input energy can include grid energy, locally generated energy, renewable energy, and so on. Energy gains can include latent energy 524. Latent energy can be captured from phase changes such as a change from a gas to a liquid, from a liquid to a solid, and so on. The latent energy can be stored. The water piston heat engine can include energy losses. Energy losses 526 can include pressure losses from pressurized vessels, temperature losses, electrical charge leakage, and so on. The system 500 includes a software-defined water piston heat engine (WPHE) 530. The software-defined WPHE can use software to configure the software-defined functions, to control energy storage and recovery, and so on. The WPHE can include an energy management system that can be operated by an energy management control system. The energy management control system can add or remove energy generation subsystems or energy storage subsystems as needed. The energy management control system can support hot-swapping of one or more subsystems. Hot-swapping subsystems can include replacing faulty subsystems, swapping out subsystems for maintenance, and the like. In embodiments, the energy management control system can control coupling of the energy, the pump-turbine subsystem, and the one or more pressure amplification pipes. The energy management control system, such as the fluid-based energy management system, includes storing energy for a period of time. The period of time can include a short-term basis or a long-term basis. In embodiments, the short-term basis can be an integer number of seconds, minutes, hours, or days, wherein the integer number of seconds, minutes, hours, or days comprises a length of time substantially less than one week. Other time increments can be used. In other embodiments, the long-term basis can be an integer number of weeks, months, seasons, or years, wherein the integer number of weeks, months, seasons, or years comprises a length of time substantially more than one day.

The system 500 includes energy storage 540. Energy that can be stored can includes electrical energy, chemical energy, mechanical energy, fluid energy, gas energy, and so on. Energy can be stored using one or more of the energy storage and generation assemblies. In embodiments, energy storage and generation assemblies comprise multiple, parallel pipes to accommodate fluid expansion or compression. As discussed throughout, the pipes, including the parallel pipes, can include a high pressure input pipe, a hierarchy of intermediate pressure pipe layers, low pressure storage pipes, and so on. In embodiments, the fluid of the one or more fluid-based energy storage and generation assemblies can include liquid air. Further liquids may also be used within the energy storage and generation assemblies. In other embodiments, the further liquids can include liquid nitrogen, Freon™, and the like.

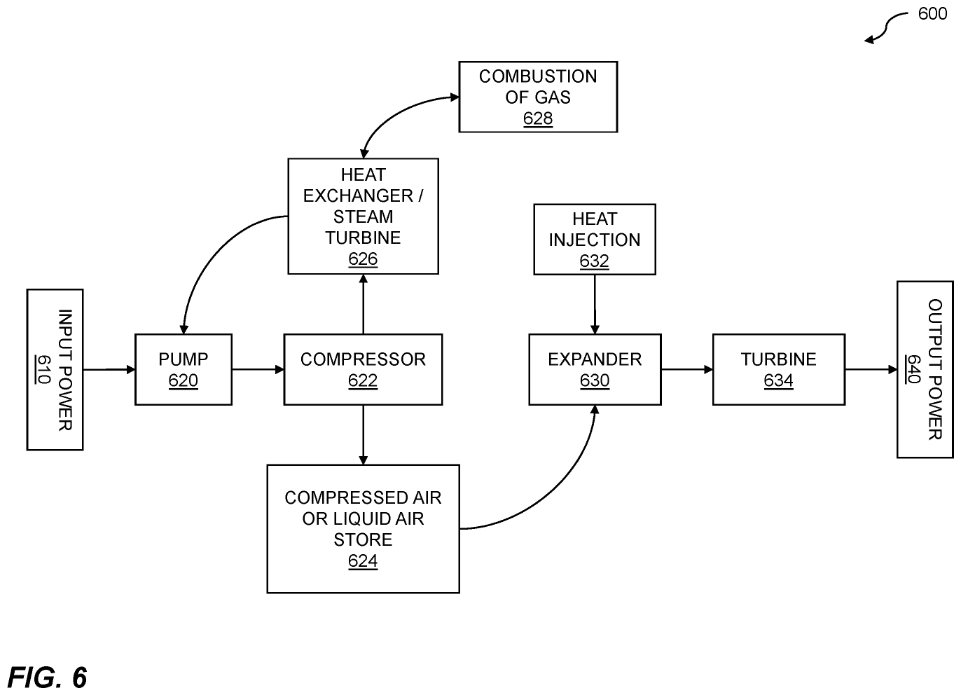

FIG. 6 illustrates energy storage and recovery 600. Energy storage and recovery can be can based on energy management. Energy management can include controlling energy storage, generation, connection, provision, delivery, and so on, where the control can be software based. Energy management can include storing energy for a period of time, where the period of time can include a short-term basis, a long-term basis, etc. The stored energy can be recovered and delivered to meet one or more energy load requirements. The energy recovery and delivery can be based on energy load requirements, seasonal adjustments, energy generation and usage policies, service level agreements, and the like. Energy storage and recovery can enable energy transfer through fluid flows for energy management. Access to a fluid-based local energy transfer distribution network is obtained. One or more fluid-based energy storage and generation assemblies are connected to the fluid-based local energy transfer distribution network. One or more fluid-based energy storage and generation assemblies are connected to the fluid-based local energy transfer distribution network. Energy is provided to the one or more fluid-based energy storage and generation assemblies. Fluid-based energy from the energy storage and generation assemblies is delivered to the fluid-based local energy transfer distribution network, wherein the delivering is based on an energy control management system executing on one or more processors.

Input power 610 can include energy sources such as grid energy from sources that are derived from coal or natural gas, hydro, and nuclear sources; and renewable energy that is derived from sources such as biogas, solar, wind, geothermal, tidal, and wave action. Energy produced from some renewable energy sources can be intermittent. Solar or wind generation relies on the presence of sunlight or wind, respectively. Energy output from solar generation is at a minimum on a cloudy day, and substantially zero at night, while wind generation is substantially zero when the wind is calm. Since energy load requirements persist even in the absence of sunlight or wind, for example, energy storage is required for energy that is generated intermittently. Energy from intermittent sources can be stored. Energy storage can be based on electrical storage, chemical storage, pressure storage, and so on. In embodiments, energy can be stored by using a pump 620. The pump can include an electrically operated pump, a pump driven by a turbine, and the like. The pump can drive a compressor 622 which can be used to store energy in various forms. In embodiments, the compressor can be used to store energy as compressed air or liquid air. The compressed air or the liquid air can be collected in a store 624. The compressor can also be used to generate steam. In embodiments, the compressor can drive a heat exchanger/steam turbine 626. The steam can be used to spin the turbine, which can be used to operate the pump 620. Energy, such as excess heat, including latent heat, can be collected using the heat exchanger. In embodiments, the collected energy can be used to preheat compressed air that can then be used to spin a turbine. As for other components related to energy storage and recovery, the heat exchanger/steam turbine can be controlled. The control can be accomplished using software-based management. In embodiments, the controlling can provide heat during expansion through combustion of a gas 628.

The compressed air or liquid air can be coupled to an expander 630. The expander can be coupled to a turbine 634, where the turbine can be spun by the release of the compressed air or liquid air. As compressed air expands or is released, the compressed air cools. The result of the cooling air can be to precipitate out any moisture that may be contained within the compressed air. The precipitating moisture can cause the turbine to freeze or ice up due to an accumulation of frost within the turbine. To prevent icing up of the turbine, heat collected by the heat exchanger can be injected 632 into the expander 630. The turbine can be coupled to or can include a generator (not shown). The generator can produce output power 640. The output power can be used to meet increased power load requirements. The output power can be generated from the stored energy, where the stored energy can be generated by the intermittent power sources. The output power can be generated from the stored energy after a period of time that is assigned on a short-term basis or a period of time that is assigned on a long-term basis.

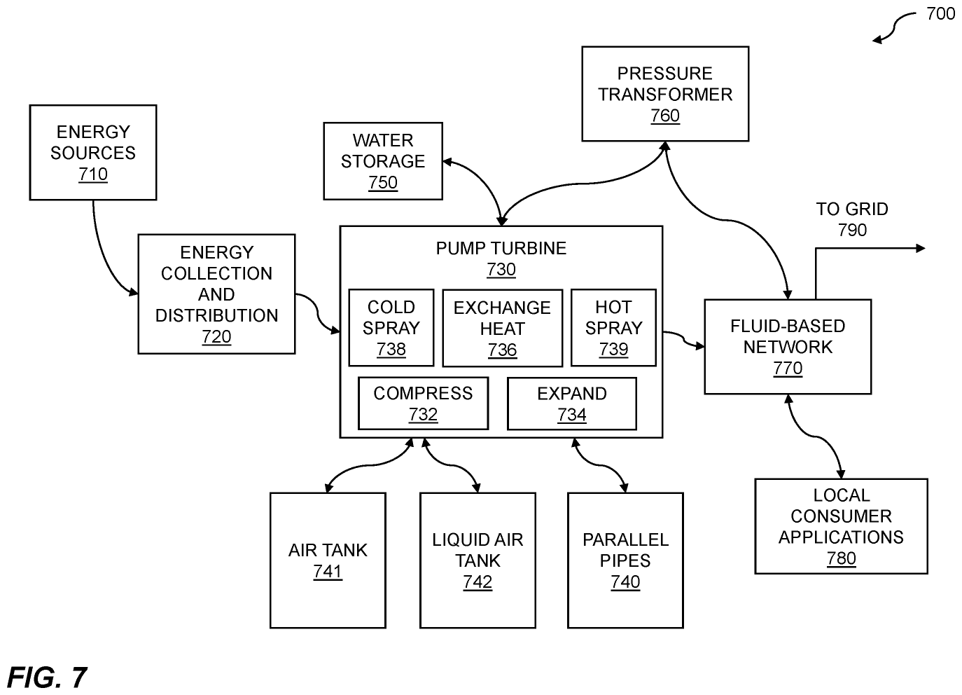

FIG. 7 shows fluid-based energy transfer. Energy transfer through fluid flows for energy management can include a variety of energy related components. The energy management that controls or manages the energy related components can be controlled by software. The software can include software-defined functions relating to energy such as generating, storing, providing, and managing energy. Energy management can include an energy internet converged infrastructure. Access to a fluid-based local energy transfer distribution network is obtained. One or more fluid-based energy storage and generation assemblies are connected to the fluid-based local energy transfer distribution network. Energy is provided to the one or more fluid-based energy storage and generation assemblies. Fluid-based energy from the energy storage and generation assemblies is delivered to the fluid-based local energy transfer distribution network, where the delivering is based on an energy control management system executing on one or more processors. The obtaining, the connecting, the providing, and the delivering comprise an energy internet converged infrastructure. The energy internet converged infrastructure enables software-controlled energy delivery optimization.

Fluid-based energy transfer 700 can include one or more components for storing or generating energy used for fluid-based energy transfer. The fluid-based energy transfer can include one or more energy sources 710. The energy sources can include electrical generation from grid sources that can include oil, coal, natural gas, or nuclear; renewable energy sources such as biogas, solar, wind, hydro, geothermal, tidal, or wave action; and the like. The renewable energy sources may be locally available on a microgrid. The energy sources can be obtained and delivered using energy collection and distribution 720. The energy collection and distribution can include coupling a fluid-based energy transfer component to one or more electrical grids, one or more microgrids, etc. The one or more electrical grids, or one or more microgrids, can include redundant energy sources such as multiple grids, backup energy sources such as diesel-generator (DG) sets, previously stored energy, and the like.

The energy from the energy sources can be provided to a pump-turbine 730. The pump-turbine can include a separate pump component and a separate turbine component, a combined single component, etc. The pump-turbine can be used to pressurize a pressure vessel, can be rotated by gas or liquid leaving the pressure vessel, and so on. The pump portion of the pump-turbine can use energy such as electrical energy to spin the turbine. The spinning turbine can be used to move gas or liquid into a vessel such as the pressure vessel, to compress a gas, etc. The turbine portion of the pump-turbine can use energy such as flowing liquid or expanding gas to spin the pump. In embodiments, the pump can be used to generate energy such as electrical energy. The pump-turbine can perform a variety of operations or functions, where the operations or functions can be controlled, and where the control of the operations or functions can be software defined. In embodiments, the pump-turbine can include a compression function 732. The compression function can compress a gas such as air or nitrogen, a specialty gas such as Freon™, etc. The compression function can be accomplished using the pump-turbine, a pump, a turbine, etc. In other embodiments, the pump-turbine can include an expansion function 734. Gas or liquid can be used to spin a turbine, the pump-turbine, and so on. The gas or liquid can be released from the pressure vessel. The pump-turbine can accomplish other operations. In further embodiments, the pump-turbine can include a heat exchanger 736. Thermal energy can be generated by compressing a gas. The thermal energy can be captured using a heat exchanger. In other embodiments, thermal energy can be injected using the heat exchanger. The pump-turbine can include a cold spray 738. In embodiments, the controlling can provide a cold water spray to provide cooling during compression. The cold spray can be used to reduce temperature of the pump-turbine or another component while a gas is being compressed. The pump-turbine can include a hot spray 739. Thermal energy can be absorbed by an expanding gas. In embodiments, the controlling can provide a hot water spray to add heat during expansion. The hot water spray can be used to inject thermal energy into the pump-turbine or other components to keep them from accumulating frost or from “freezing up” if water vapor in the gas condenses.

Discussed throughout, the pump-turbine can pressurize multiple pipes, a pressure vessel, and so on. In embodiments, the energy storage and generation assemblies can include multiple, parallel pipes 740 to accommodate fluid expansion or compression. The multiple, parallel pipes can be organized into a variety of configurations. In embodiments, the multiple, parallel pipes can be configured in a hierarchy. In embodiments, the pressure vessel can include an air tank 741. The air tank can store a compressed gas such as air or nitrogen, or a specialty gas such as Freon™. In embodiments, the pressure vessel can include a tank for liquefied gases, such as liquid air tank 742. In other embodiments, the liquid air can be supplied to the distribution network at a temperature less than −215° C. The air compression tank can be used to pressurize another tank, cavity, and so on. In embodiments, the pump-turbine can be used to pressurize a cavern. The cavern can include a void below ground, a capsule positioned underwater, and so on. In other embodiments, the pump-turbine can be used to pressurize other infrastructure such as unused oil infrastructure. The pump-turbine can be used to pressurize unused oil wells. The compression accomplished by the pump-turbine can include one or more liquids. In embodiments, energy can be stored in water storage 750. Water storage can include pumping water to higher elevation to create a fluid head, where the fluid head can be used to spin a turbine for energy generation. The water can be fresh water, salt water, or brackish water.

In embodiments, at least one of the one or more fluid-based energy storage and generation assemblies can include a pump running at an optimum performance-pressure point. An optimum performance-pressure point can be controlled by software. The optimum performance-pressure point can be determined by design, by measuring pump performance, etc. Further embodiments include converting the pump optimum performance-pressure point pressure to a required pressure within the fluid-based local energy transfer distribution system using a pressure transformer amplifier 760. The pressure transformer function can be accomplished using a variety of techniques. In embodiments, the pressure transformer amplifier can use two or more pressure amplification pipes. The pressure amplifier pipes can be organized in different configurations, where the configurations can include a hierarchy. In embodiments, the hierarchy can include 2-to-1 piping for compression or 1-to-2 piping for expansion. The number of levels within the hierarchy can be chosen based on design, optimization, and the like. In embodiments, the hierarchy comprises no more than seven levels to achieve at least 100 times pressure expansion or contraction.

Fluid-based energy transfer can include a fluid-based network 770. A fluid-based network, such as a fluid-based local energy transfer distribution network can be based on one or more fluids, one or more gases, and so on. In embodiments, the fluid-based local energy transfer distribution network can include at least two heterogeneous fluids. A given fluid can include multiple phases. In embodiments, the fluid-based local energy transfer distribution network includes a homogeneous fluid in liquid and gaseous phases. The fluid-based network can provide one or more services, where the one or more services can meet various types of applications. In embodiments, the local, fluid-based services can supply local consumer applications 780. Consumer applications can include residential applications, public or governmental applications, manufacturing or processing applications, and the like. In embodiments, the local consumer applications can include a water nozzle, an air nozzle, a water Venturi function, an air Venturi function, a vacuum supply, space heating, a fluid-based rotation, space cooling, hot water, or cold water. Fluid-based energy transfer can be used for energy distribution. Energy distribution can include distributing energy locally such as around a plant or facility, a farm, a neighborhood, and so on. Energy distribution can include delivering energy from the pump-turbine to a local grid or micro-grid. Energy distribution can include providing energy farther afield. The energy distribution can include providing energy to a grid 790. The grid can include a municipal grid, a state-wide grid, a regional grid, a national grid, etc.

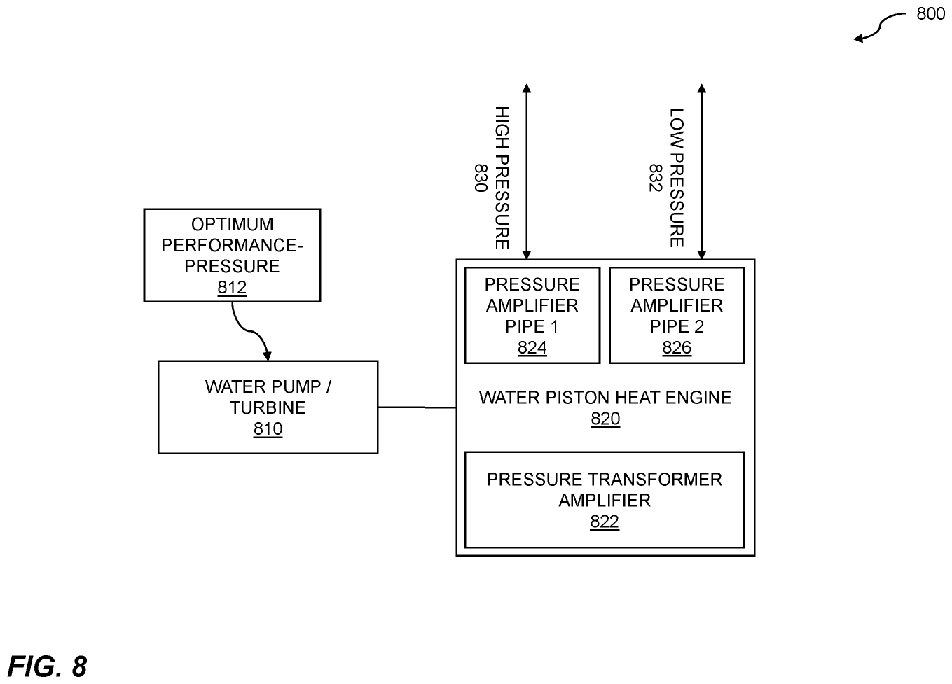

FIG. 8 illustrates fluid-based pump energy input/output. Input energy or output energy, including grid energy, renewable energy, and so on, can be stored or provided based on gaseous energy transfer, liquid energy transfer, electrical energy storage, chemical energy storage, and so on. Energy can further be stored or provided using pressure amplification, where the pressure amplification can be based on pressure amplifier pipes. The energy that is stored or provided can be transferred through fluid flows. The fluid flows enable energy transfer for energy management. Access to a fluid-based local energy transfer distribution network is obtained. One or more fluid-based energy storage and generation assemblies are connected to the fluid-based local energy transfer distribution network. Energy is provided to the one or more fluid-based energy storage and generation assemblies. A fluid-based energy storage and generation assembly can include a pump-turbine subsystem. Fluid-based energy from the energy storage and generation assemblies is delivered to the fluid-based local energy transfer distribution network. The delivering is based on an energy control management system executing on one or more processors.

Fluid-based pump energy input 800 can include a water pump/turbine 810. The water pump/turbine can be a component of a fluid-based energy storage and generation assembly. While a water pump/turbine is shown and described, the pump/turbine can include a pump for pumping gases, a pump for two phases of matter such as gas and liquid, a pump for a slurry, and so on. The fluid-based pump can be integral to the pump-turbine component, a standalone pump, etc. In embodiments, at least one of the one or more fluid-based energy storage and generation assemblies can include a pump running at an optimum performance-pressure point 812. An optimum performance-pressure point can be determined based on the design of the fluid-based energy storage and generation assembly, on past performance of the assembly, and so on. The optimization can be accomplished by adjusting pump speed, fluid pressure, and the like. Further embodiments can include converting the pump optimum performance-pressure point pressure to a required pressure within the fluid-based local energy transfer distribution system using a pressure transformer amplifier.

The water pump/turbine can provide input energy to a water piston heat engine 820 (WPHE). A WPHE, or a liquid piston heat engine, can be used to convert the liquid or gas provided by the pump to a storage format. The WPHE can transform the input energy to a variety of energy storage formats. In embodiments, the WPHE sends energy to a pressure transformer amplifier 822. More than one pressure transformer amplifier may be coupled to the WPHE. As described throughout, the pressure transformer amplifier can include one or more pressure amplifier pipes such as pressure amplifier pipe 1 824 or pressure amplifier pipe 2 826. More than two pressure amplifier pipes can be connected to the pressure transformer amplifier. The one or more pressure transformer amplifier pipes can provide a high pressure 830 or a low pressure 832. Water pump/turbine energy can be stored in various other formats. In embodiments, the WPHE can send energy to storage via liquid energy transfer. The energy can be stored in a liquid format. Liquid energy transfer can be accomplished using a heat exchanger, a heat injector, a chiller, and so on. Liquid sources can include liquefied gases such as liquid air, ice, an ice-slurry, etc. One or more gases can receive energy through gaseous energy transfer. The WPHE can send energy to gaseous storage formats. The gaseous storage formats can include a vacuum, air, a gas, and so on. The gas can include a specialized gas such as Freon™. The WPHE can transform the energy that can be received from the water pump/turbine to energy for storage in a pressure amplifier, to liquid energy transfer, or to gaseous energy. The transfer can be accomplished using the mechanical energy of the water pump/turbine.

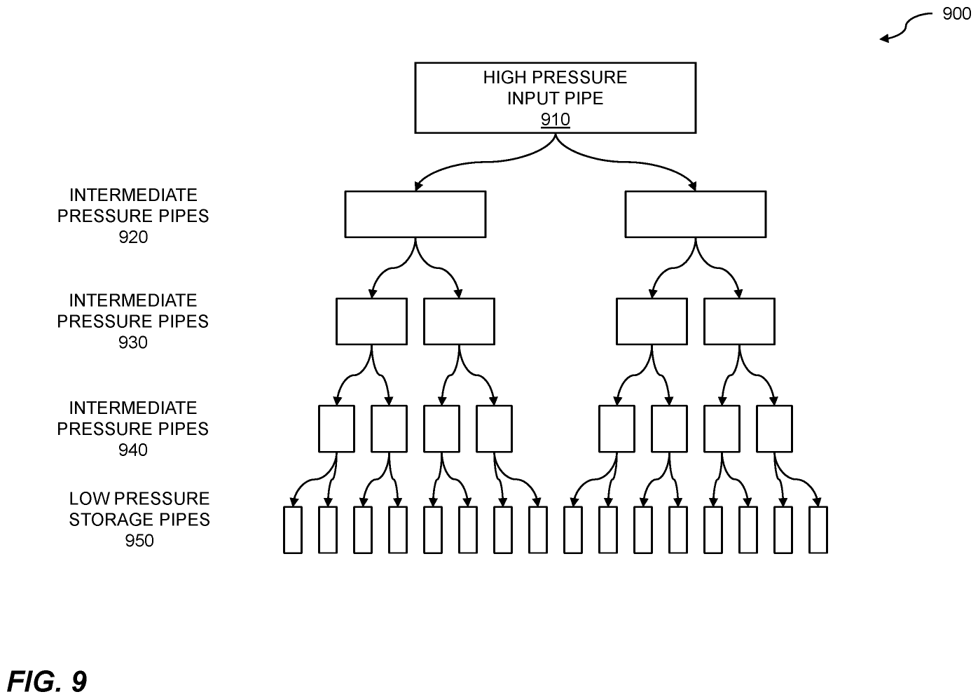

FIG. 9 shows piping for pressure storage in hierarchies. A fluid-based local energy transfer distribution network can include energy storage and generation assemblies. Energy storage can be based on pressure storage using a pressure transformer amplifier. The pressure transformer amplifier can use two or more pressure amplification pipes to accomplish the pressure storage. Pressure storage enables energy transfer through fluid flows for energy management. Access to a fluid-based local energy transfer distribution network is obtained. One or more fluid-based energy storage and generation assemblies are connected to the fluid-based local energy transfer distribution network. Energy is provided to the one or more fluid-based energy storage and generation assemblies. Fluid-based energy is delivered from the energy storage and generation assemblies to the fluid-based local energy transfer distribution network, wherein the delivering is based on an energy control management system executing on one or more processors.

Pressure storage 900 can be accomplished using a hierarchy of pressure amplification pipes. Fluid, gas, or multiphase fluid and gas can be provided using a high pressure input pipe 910. The high pressure fluid, gas, etc., can be stored in a hierarchy of intermediate pressure pipes. The intermediate pressure pipes can include a first set of intermediate pressure pipes 920, a second set of intermediate pressure pipes 930, a third set of intermediate pressure pipes 940, low pressure storage pipes 950, and so on. While five levels of hierarchy, including the high pressure input pipe, are shown, other levels of hierarchy can be used. The pressure of the fluid, liquid, etc., is reduced by the number of pipes when there are more intermediate pressure pipes than input pressure pipes. The amount of pressure change is dependent on the number of intermediate pipes, the relative sizes of the intermediate pipes, and so on. If there are a number of intermediate level pipes of equal dimensions to each other, the pressure of the input pipe is divided or partitioned evenly by the number intermediate pipes. Conversely, the pressure of the fluid, gas, etc. can be increased when a larger number of pipes are coupled to a smaller number of pipes.

In the example, the fluid, gas, etc., of the high pressure input pipe is partitioned across the two pipes of the first set of intermediate pressure pipes 920. The partitioning of the intermediate pressure within the first set of intermediate pressure pipes 920 continues to further divide across the second set of intermediate pressure pipes 930. This partitioning proceeds from a level of intermediate pressure pipes to a next level of intermediate pressure pipes. At the bottom of the pressure storage hierarchy, sixteen low pressure storage pipes can each store one sixteenth ( 1/16) of the pressure within the high pressure input pipe 910. When high pressure is once again required, the low pressure within the low pressure storage pipes 950 can be recombined across the hierarchy of intermediate pressure pipes. The recombining of the pressure in the low pressure storage pipes across the hierarchy of intermediate pressure pipes 940, 930, and 920 results in high pressure at the high pressure input pipe 910.

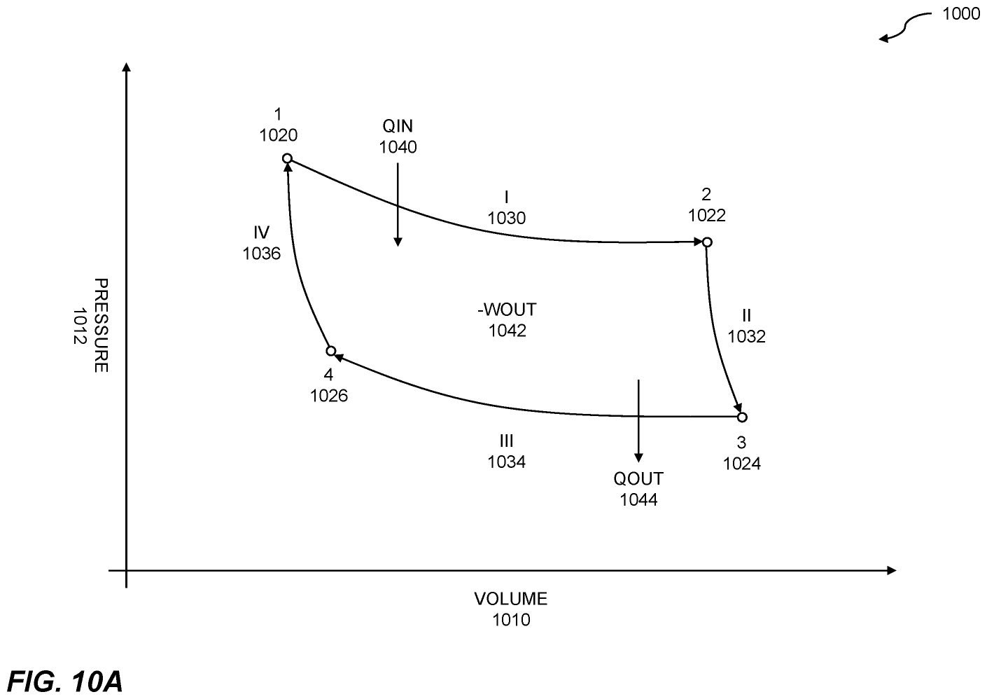

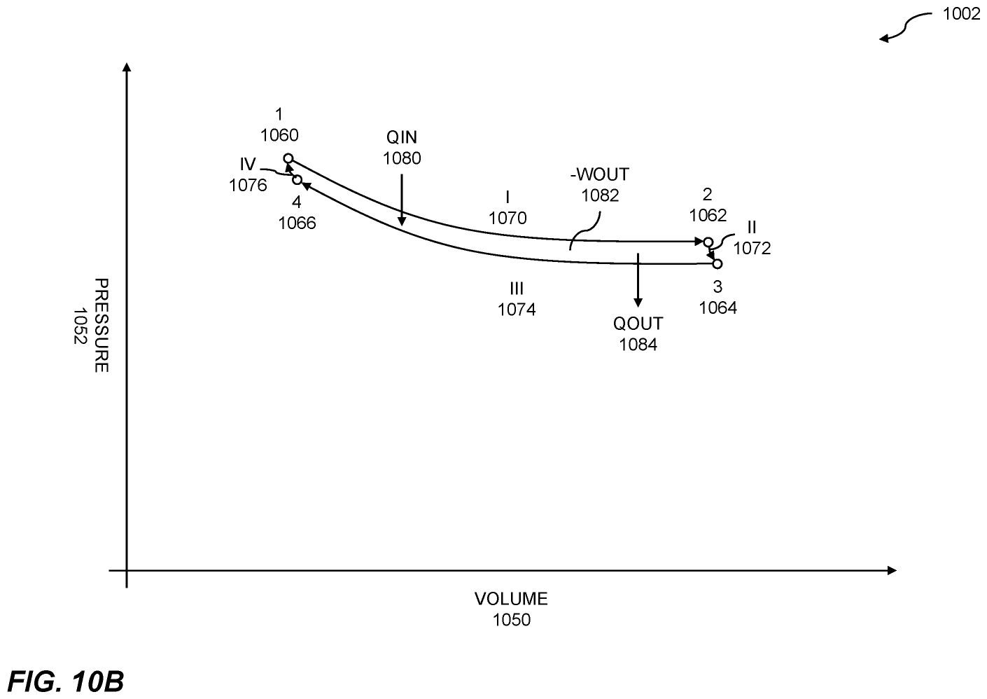

FIG. 10A illustrates adiabicity in a heat transfer cycle. An adiabatic process can occur when neither heat nor mass of a material is transferred between a given thermodynamic system and the environment that surrounds the thermodynamic system. “Adiabaticity” can describe a quality of the adiabatic process. For the techniques described herein, an adiabatic process with adiabicity equal to zero percent is described as perfectly isothermal, while an adiabatic process with adiabicity equal to 100 percent is described as perfectly adiabatic. Adiabaticity in a heat transfer cycle supports energy transfer through fluid flows. Access to a fluid-based local energy transfer distribution network is obtained. One or more fluid-based energy storage and generation assemblies are connected to the fluid-based local energy transfer distribution network. Energy is provided to the one or more fluid-based energy storage and generation assemblies. Fluid-based energy from the energy storage and generation assemblies is delivered to the fluid-based local energy transfer distribution network, where the delivering is based on an energy control management system executing on one or more processors.

The figure shows a pressure-volume (PV) diagram 1000. A PV diagram can be used to show changes in pressure 1012 versus volume 1010 for one or more thermodynamic processes. A cycle, such as a heat transfer cycle, can be based on the one or more thermodynamic processes. One lap around the cycle can complete the cycle, where the completed cycle can result in a net no change of system state. With reference to the PV diagram, at the end or completion of the cycle, the thermodynamic system state returns to a pressure and a volume equal to the pressure and the volume of the system at the beginning of the cycle. Four states are shown: state 1 1020, state 2 1022, state 3 1024, and state 4 1026. Each state (1 through 4) represents a pressure and a corresponding volume. While four states are shown, other numbers of states may be present for a given cycle. A path between two states can represent a process. Four processes are shown: process I 1030, process II 1032, process III 1034, and process IV 1036. While four processes are shown, other numbers of processes may be present within a given cycle.

A given process can affect a system pressure, a system volume, or both a system pressure and a system volume. For the heat transfer cycle shown, the processes can be isothermal (such as process I and process III), or adiabatic (such as process II and process IV). In general, the four processes shown can include isothermal expansion, such as between points 1 and 2; reversible adiabatic or isentropic expansion, such as between points 2 and 3; reversible isothermal compression, such as between points 3 and 4; and reversible adiabatic or isentropic compression, such as between points 4 and 1. Using the first law of thermodynamics, for a closed system, an amount of internal energy of the closed system can be calculated based on a quantity of input heat, such as input heat qin 1040 minus an amount of work performed by the system, such as -wout 1042. Any heat removed from the system, such as output heat qout 1044 can be determined to be equal to the quantity of input heat minus work.

FIG. 10B illustrates an isothermal heat transfer cycle. A cycle of a thermodynamic system can include one or more thermodynamic processes. The thermodynamic processes can include isothermal processes and adiabatic processes. When the adiabicity of adiabatic processes is nearly equal to zero, then the thermal dynamic system can be described approximately as an isothermal system. An isothermal heat transfer thermodynamic system can support energy transfer through fluid flows. Access to a fluid-based local energy transfer distribution network is obtained, and one or more fluid-based energy storage and generation assemblies are connected to the network. Energy is provided to the one or more fluid-based energy storage and generation assemblies, and fluid-based energy from the energy storage and generation assemblies is delivered to the fluid-based local energy transfer distribution network. The delivering is based on an energy control management system executing on one or more processors.

A pressure-volume (PV) diagram is shown in the FIG. 1002. The PV diagram can plot pressure versus volume, and can show one or more states, where each state 1 through 4 comprises a pressure 1052 and a corresponding volume 1050. Four states are shown: state 1 1060, state 2 1062, state 3 1064, and state 4 1066. While four states are shown, other numbers of states may be present for a given cycle. A path between two states can represent a process. A process can include an isothermal process or an adiabatic process. A given process can impact the thermodynamic system by changing pressure, volume, or both pressure and volume. Four processes are shown: process I 1070, process II 1072, process III 1074, and process IV 1076. While four processes are shown, other numbers of processes may be present within a given cycle. For the isothermal heat transfer cycle shown, process I and process III can be isothermal. The adiabatic processes, process II and process IV can be as close to zero possible. The adiabatic processes II and IV can have an adiabicity nearly equal to zero. Recall that for a closed thermodynamic system, an amount of internal energy of the closed system can be calculated based on a quantity of input heat, such as input heat qin 1080 minus an amount of work performed by the system, such as -wout 1082. Any heat removed from the system, such as output heat qout 1084 can be determined to be equal to the quantity of input heat minus work.

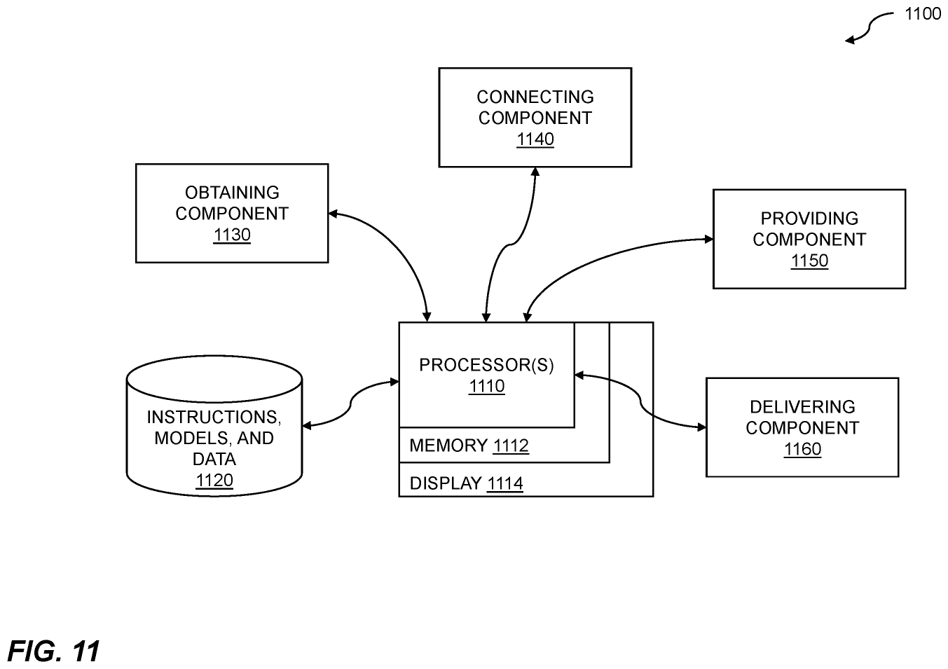

FIG. 11 is a system diagram for energy management using a fluid-based infrastructure. Energy management is based on energy transfers through fluid flows. Access to a fluid-based local energy transfer distribution network is obtained. One or more fluid-based energy storage and generation assemblies are connected to the fluid-based local energy transfer distribution network. Energy is provided to the one or more fluid-based energy storage and generation assemblies. Fluid-based energy is delivered from the energy storage and generation assemblies to the fluid-based local energy transfer distribution network, wherein the delivering is based on an energy control management system executing on one or more processors. The delivering includes providing local, fluid-based services, where the local, fluid-based services supply local consumer applications. The local consumer applications include a water nozzle, an air nozzle, a water Venturi function, an air Venturi function, a vacuum supply, space heating, a fluid-based rotation, space cooling, hot water, or cold water. The system can be controlled to enable isothermal operation of one or more fluid-based energy storage and generation assemblies. Isothermal operation can have an adiabicity of zero percent.

The system 1100 can include one or more processors 1110 and a memory 1112 which stores instructions. The memory 1112 is coupled to the one or more processors 1110, wherein the one or more processors 1110 can execute instructions stored in the memory 1112. The memory 1112 can be used for storing instructions; for storing databases of energy subsystems, modules, or peers for system support; and the like. Information regarding energy transfer through fluid flows for energy management can be shown on a display 1114 connected to the one or more processors 1110. The display can comprise a television monitor, a projector, a computer monitor (including a laptop screen, a tablet screen, a netbook screen, and the like), a smartphone display, a mobile device, or another electronic display. The system 1100 includes instructions, models, and data 1120. The data can include information on energy sources, energy conversion requirements, metadata about energy, and the like. In embodiments, the instructions, models, and data 1120 are stored in a networked database, where the networked database can be a local database, a remote database, a distributed database, and so on. The instructions, models, and data 1120 can include instructions for obtaining access to one or more fluid-based local energy transfer distribution networks. The instructions, models, and data can further include operating data obtained from a plurality of fluid-based local energy transfer distribution networks, one or more operating goals for the plurality of fluid-based local energy transfer distribution networks, instructions for analyzing operating data, instructions for controlling the operation of energy storage and generation assemblies, etc. In embodiments, at least one of the one or more fluid-based energy storage and generation assemblies includes a pump running at an optimum performance-pressure point. An optimum performance-pressure point can be determined based on the design of the energy storage and generation assembly, on the past operation of the assembly, etc. Further embodiments include converting the pump optimum performance-pressure point pressure to a required pressure within the fluid-based local energy transfer distribution system using a pressure transformer amplifier.

The system 1100 includes an obtaining component 1130. The obtaining component 1130 can obtain access to a fluid-based local energy transfer distribution network. The fluid-based local energy transfer distribution network can be based on one fluid. The homogeneous fluid can include more than one phase. In embodiments, the fluid-based local energy transfer distribution network can include a homogeneous fluid in liquid and gaseous phases. The fluid-based local energy transfer distribution network can be based more than one fluid. In embodiments, the fluid-based local energy transfer distribution network can include at least two heterogeneous fluids. The liquid or liquids can include a variety of liquids. In embodiments, the fluid-based energy comprises liquid air, where the liquid air can be supplied to the distribution network at a temperature less than −215° C.

The system 1100 includes a connecting component 1140. The connecting component 1140 can connect one or more fluid-based energy storage and generation assemblies to the fluid-based local energy transfer distribution network. The connecting can be controlled or configured by an energy control management system. In embodiments, the energy control management system can control fluid connections within one or more fluid-based energy storage and generation assemblies. Energy storage can be based on air, steam, liquid nitrogen, ice, ice-slurry, and so on. In embodiments, the controlling fluid connections is accomplished with a flow control module. The flow control module can control pumps, pump-turbines, valves, and the like. In embodiments, the controlling fluid connections can be performed by electrically-controlled valves. The connecting can include an energy interconnect, where the energy interconnect can include a local electrical grid. The local electrical grid can be local to the one or more fluid-based energy storage and generation assemblies. The energy interconnect can include performing the energy interconnect without converting the energy to another form such as an intermediate form. In embodiments, the energy interconnect can be performed without an electrical subsystem intermediary. The energy interconnect can interconnect energy storage and generation assemblies including fluid-based energy storage and generation assemblies. In embodiments, the energy interconnect can include a local electrical grid. The system 1100 includes a providing component 1150. The providing component can provide energy to the one or more fluid-based energy storage and generation assemblies. The energy that can be provided can be obtained from a variety of energy sources such as grid energy sources including coal, natural gas, or nuclear; renewable energy sources including biogas, wind, solar, tidal, or wave action; and so on. The grid energy, renewable energy, etc., can be used to operate a pump-turbine, where the pump-turbine can transfer a gas or liquid, compress a gas, and the like. The providing can be controlled or adjusted.

The system 1100 includes a delivering component 1160. The delivering component can include delivering fluid-based energy from the energy storage and generation assemblies to the fluid-based local energy transfer distribution network. The delivering is based on an energy control management system executing on one or more processors. In some embodiments, the delivering component can deliver electrical energy from the energy interconnect. The electrical energy can result from operating a pump-turbine. In embodiments, the delivering includes providing local fluid-based services. Various types of services can be provided based on a variety of fluids. In embodiments, the local, fluid-based services can supply local consumer applications. The consumer application can be related to domestic or dwelling services for housing; industrial or commercial services, and the like. In embodiments, the local consumer applications can include a water nozzle, an air nozzle, a water Venturi function, an air Venturi function, a vacuum supply, space heating, a fluid-based rotation, space cooling, hot water, or cold water. The delivering component can deliver mechanical energy. In embodiments, the delivering can include providing a fluid-based equivalent mechanical range of motion through fluid transfer. The delivering can be based on a single fluid or on two or more fluids. In embodiments, the delivering can include heterogeneous fluid pressure transformation using a mechanical connection. The one or more processors of the energy management system can execute instructions, models, energy policies, and so on. The energy management system can adjust an amount of energy that is provided. In embodiments, the providing can be based on feedback to the energy control management system. The feedback can include available energy supply, energy consumption requirements, seasonal factors, etc. In embodiments, the feedback can include energy supply updates or energy demand updates, where the updates can be based on sampling. The providing energy can be based on profiles. In embodiments, the energy control management system can use supply profiles and demand profiles to adjust the delivering.

The system 1100 can include a computer system for energy management comprising: a memory which stores instructions; one or more processors coupled to the memory wherein the one or more processors, when executing the instructions which are stored, are configured to: obtain access to a fluid-based local energy transfer distribution network; connect one or more fluid-based energy storage and generation assemblies to the fluid-based local energy transfer distribution network; provide energy to the one or more fluid-based energy storage and generation assemblies; and deliver fluid-based energy from the energy storage and generation assemblies to the fluid-based local energy transfer distribution network, wherein the delivering is based on an energy control management system executing on one or more processors. Disclosed embodiments can include a computer program product embodied in a non-transitory computer readable medium for energy management, the computer program product comprising code which causes one or more processors to perform operations of: obtaining access to a fluid-based local energy transfer distribution network; connecting one or more fluid-based energy storage and generation assemblies to the fluid-based local energy transfer distribution network; providing energy to the one or more fluid-based energy storage and generation assemblies; and delivering fluid-based energy from the energy storage and generation assemblies to the fluid-based local energy transfer distribution network, wherein the delivering is based on an energy control management system executing on one or more processors.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for energy management comprising:
obtaining access to a fluid-based local energy transfer distribution network;
connecting one or more fluid-based energy storage and generation assemblies to the fluid-based local energy transfer distribution network;
providing energy to the one or more fluid-based energy storage and generation assemblies; and
delivering fluid-based energy from the energy storage and generation assemblies to the fluid-based local energy transfer distribution network, wherein the delivering is based on an energy control management system executing on one or more processors.

2. The method of claim 1 wherein the delivering includes providing local, fluid-based services.

3. The method of claim 2 wherein the local, fluid-based services supply local consumer applications.

4. The method of claim 3 wherein the local consumer applications include a water nozzle, an air nozzle, a water Venturi function, an air Venturi function, a vacuum supply, space heating, a fluid-based rotation, space cooling, hot water, or cold water.

5. The method of claim 1 wherein the delivering includes providing a fluid-based equivalent mechanical range of motion through fluid transfer.

6. The method of claim 5 wherein the equivalent mechanical range of motion controls fluid mixing.

7. The method of claim 5 wherein the equivalent mechanical range of motion controls fluid velocity.

8. The method of claim 5 wherein the equivalent mechanical range of motion controls fluid rotation.

9. The method of claim 1 wherein the delivering includes heterogeneous fluid pressure transformation using a mechanical connection.

10. The method of claim 1 wherein the fluid-based local energy transfer distribution network includes at least two heterogeneous fluids.

11. The method of claim 1 wherein the fluid-based local energy transfer distribution network includes a homogeneous fluid in liquid and gaseous phases.

12. The method of claim 1 wherein the fluid-based energy comprises hot air.

13. The method of claim 12 wherein the hot air is supplied to the distribution network at a temperature greater than ambient air temperature.

14. The method of claim 1 wherein the fluid-based energy comprises liquid air.

15. The method of claim 14 wherein the liquid air is supplied to the distribution network at a temperature less than −215° C.

16. The method of claim 1 wherein the fluid-based energy comprises cold air.

17. The method of claim 16 wherein the cold air is supplied to the distribution network at a temperature less than ambient air temperature.

18. The method of claim 1 wherein the fluid-based energy comprises vacuum services.

19. The method of claim 18 wherein the vacuum services are supplied to the distribution network at a pressure of less than 14 pounds per square inch vacuum (PSIV).

20. The method of claim 1 wherein the fluid-based energy comprises pressurized water.

21. The method of claim 20 wherein the pressurized water is supplied to the distribution network at a pressure of more than one bar.

22. The method of claim 1 wherein the delivering is performed without an electrical subsystem intermediary.

23. The method of claim 1 wherein the energy storage and generation assemblies comprise multiple, parallel pipes to accommodate fluid expansion or compression.

24. The method of claim 23 wherein the multiple, parallel pipes are configured in a hierarchy.

25. The method of claim 24 wherein the hierarchy comprises 2-to-1 piping for compression or 1-to-2 piping for expansion.

26. The method of claim 25 wherein the hierarchy comprises no more than seven levels to achieve at least 100 times pressure expansion or contraction.

27. A computer program product embodied in a non-transitory computer readable medium for energy management, the computer program product comprising code which causes one or more processors to perform operations of:
obtaining access to a fluid-based local energy transfer distribution network;
connecting one or more fluid-based energy storage and generation assemblies to the fluid-based local energy transfer distribution network;
providing energy to the one or more fluid-based energy storage and generation assemblies; and
delivering fluid-based energy from the energy storage and generation assemblies to the fluid-based local energy transfer distribution network, wherein the delivering is based on an energy control management system executing on one or more processors.

28. A computer system for energy management comprising:
a memory which stores instructions;
one or more processors coupled to the memory wherein the one or more processors, when executing the instructions which are stored, are configured to:
obtain access to a fluid-based local energy transfer distribution network;
connect one or more fluid-based energy storage and generation assemblies to the fluid-based local energy transfer distribution network;
provide energy to the one or more fluid-based energy storage and generation assemblies; and
deliver fluid-based energy from the energy storage and generation assemblies to the fluid-based local energy transfer distribution network, wherein the delivering is based on an energy control management system executing on one or more processors.
